(19) United States
(12) Patent Application Publication
(10) Pub. No.: US 2009/0002487 A1
(43) Pub. Date: Jan. 1, 2009

(54) Portable Vehicle Mounted Monitoring System

(76) Inventor: Martin Poulin, Derry, NH (US)

Correspondence Address: LAMBERT & ASSOCIATES, P.L.L.C., 92 STATE STREET, BOSTON, MA, 02109-2004, US

(21) Appl. No.: 11/768,268

(22) Filed: Jun. 26, 2007

(51) Int. Cl. H04N 7/18

(52) U.S. Cl. 348/118

(57) ABSTRACT

A portable vehicle mounted monitoring system to aide an operator of a vehicle while traveling in the rearward direction. The system includes an image receiving means capable of relaying real-time images from behind the vehicle to an image display means located inside the vehicle. The image receiving means and the image display means both contain mounting apparatuses which allows for each component of the system to be temporarily attached to the vehicle and to be removed after the intended use for the system has been completed.

### BACKGROUND OF THE INVENTION

1. Field of the Invention

The present invention relates generally to vehicle monitoring systems, and in particular to a portable vehicle mounted monitoring system, which assist drivers, especially when the vehicle is moving rearward to its normal direction of travel.

2. Description of the Related Art

The guiding of a vehicle for attachment or hook-up to a trailer for example, is usually a difficult and time-consuming matter that requires multiple individuals to be involved in the attachment. Furthermore, on the whole, individuals who attach their vehicles to trailers for personal use do so infrequently, and as a result fail to achieve or retain the expertise needed for this process. Without this expertise, at least two people must be involved in the attachment of the trailer. One individual must operate the vehicle, while a second individual stands between the vehicle and trailer and directs the individual operating the vehicle. Additionally, even with two or more individuals, this process becomes more complicated or almost impossible in adverse weather conditions or during the nighttime.

The present invention relates to a portable vehicle mounted monitoring system that assists an individual operating a vehicle in the rearward direction, for example while attempting to attach a trailer to a vehicle. Many systems have been developed to provide some type of visual aid to drivers, especially while drivers are engaged in rearward travel. However, previous attempts to provide such a system have been difficult to use, even though they have assisted drivers somewhat. Ultimately, it is the goal of such a system to provide a visual aid that can be easily installed and easily removed from a vehicle, wherein the system utilizes a camera to relay real-time images to a monitor mounted inside the vehicle allowing the driver to unilaterally attach components such as a trailer to a vehicle.

Presently, there are several visual aid systems that employ a variety of means to assist and/or alert the operator of a vehicle while traveling in the rearward direction. One of the most common types of systems involves illumination of the applicable devices so that the system can be viewed during nighttime. However, this system uses batteries or some other electrical apparatus, that if the system was stored for an extended period of time, the illuminating device would not operate properly as the batteries would be exhausted.

Another common visual aid system employs the use of a camera permanently mounted to the trunk of a vehicle, wherein the camera relays images to a monitor that is mounted inside the vehicle. Since the camera is permanently mounted to the vehicle, unfortunately an individual is not able to transfer the system to another vehicle for use; moreover, the position of the camera on the vehicle is fixed and does not provide the flexibility of different viewing angles.

A large number of visual aid systems for drivers are known in the art, and in fact are in wide use in the industry. But there exists in the art no portable vehicle mounted monitoring system that employs a camera to relay images to a monitor inside the vehicle and thus assist an operator while traveling in the rearward direction, while allowing the monitoring system to be transferred from one vehicle to another, wherein the camera is able to provide different viewing angles.

U.S. Pat. No. 7,006,127 to Mizusawa et al. discloses a driving aiding system that includes a displaying section arranged at a position that can be looked at from a driver's seat of a vehicle, an image picking-up section for picking up an image of a rear portion of the vehicle containing at least a part of a hitch that is provided to the rear portion of the vehicle, and an image processing section for causing the displaying section to display a synthesized image that is obtained by image-processing an image picked up by the image picking-up section.

U.S. Pat. No. 6,765,607 to Mizusawa et al. discloses a driving aiding system for displaying a picked-up image of a rear-view camera equipped onto a rear portion of a vehicle on a screen of a displaying means arranged at a position which can be viewed from a driver's seat when the vehicle is to be backed, a locus estimated line of a hitch which is equipped onto a rear portion of the vehicle is superposed on the picked-up image of the rear-view camera to display when a predetermined instruction input is received.

U.S. Pat. No. 6,977,584 to Milliken discloses a vehicle-in-motion warning apparatus having one or more warning device and a light source in a housing. The warning device may be an audible, visual, or objecting-sensing device, and is mounted behind a grill which is integrally formed with the housing face. The light source is mounted in front of the housing face and covered with a removeable transparent cover. The housing may be either formed to fit a vehicle recess or alternatively formed to fit into a trailer hitch receiver. The associated wiring harness is terminated with a standard connector which allows the apparatus to be plugged into the existing vehicle wiring harness without modification, or a pigtail for splicing into the wiring harness.

U.S. Pat. No. 6,933,837 to Gunderson et al. discloses a trailer based collision warning system which includes one or more side object detection sensors, one or more backup assist sensors, a driver vehicle interface, and trailer-mounted display units operating essentially independent of the tractor with all detection and warning system equipment mounted on the trailer. The trailer based collision warning system is coupled to industry-standard tractor to trailer wiring to provide the trailer with power and signals such as left turn indication and right turn indication. The side and rear sensors detect the presence and location of objects and transfer this information to a driver vehicle interface device located on the trailer. The system can also be equipped with video cameras with a means of automatically activating the camera in the area where a hazard condition has been detected. The driver vehicle interface determines the nature of the information and/or warning needed by the driver and provides this information in the form of signals sent to displays that can to assist the driver in safely maneuvering the trailer. The collision warning system can also operate in a security mode.

U.S. Pat. No. 6,693,519 to Keirstead discloses a vehicle monitoring systems capable of being retrofitted to a commercial transport carrier having a video camera, a fastening bracket for securing the video camera to a first point of attachment on the transport carrier, a ball mount and screw mechanism, a camera support bracket, a monitor support bracket for securing the monitor to a second point of attachment in the cab of the transport carrier, and a coaxial cable for relaying images from the video camera to the monitor, wherein the video camera is adjustably mounted to the first point of attachment and the monitor is adjustably mounted to the second point of attachment. Upon retrofit, the monitoring system provides a rear-view image of areas adjacent the commercial transport carrier (i.e., blind spots), thereby enhancing the driver's situational awareness, preventing highway accidents, and promoting highway safety.

U.S. Pat. No. 5,927,229 to Karr, Jr. discloses a visual aid system for attachment of a hitch of a motor vehicle to a trailer including a first pole cantably attached onto the hitch connector ball of the motor vehicle and a second pole articulated to the hitch mechanism of the trailer so as to move to a position directly above the socket of the hitch mechanism. The first pole includes a pole member and a receptacle affixed to a lower end of the pole member. The receptacle has a groove formed circumferentially around an interior thereof. An elastomeric band is located within the groove so as to be interposed between the ball and the receptacle. The second pole includes a pole member, an articulatable connector pivotally connected to an end of the pole member, and a base affixed to the hitch mechanism of the trailer. The articulatable connector is pivotally connected to the base. A phosphorescent cap is affixed to a top of the first pole so as to emit light outwardly from an upper portion of the first pole. A phosphorescent cap is affixed to a top of the second pole so as to emit light outwardly from an upper portion of the second pole.

In summary, investigation of these disclosed devices illustrates that presently, there is no single device known in the art that meets the requirements of a portable vehicle monitoring system as nothing in the prior art discloses a vehicle monitoring system that utilizes a camera with different viewing angles, and wherein the system is transferable from one vehicle to another.

### SUMMARY OF THE INVENTION

The present invention, as described further herein, imparts a novel vehicle monitoring system which encompasses the advantages of other driving aid systems, but creates flexibility in where an individual wishes to place the system and the angle at which an image receiving means is positioned. The instant invention, as illustrated herein, is clearly not anticipated, rendered obvious, or even present in any of the prior art mechanisms, either alone or in any combination thereof.

The primary object of the present invention is to provide a system to aide an operator of a vehicle while traveling in the rearward direction by allowing the operator to view real-time images directly behind the vehicle.

Another object of the present invention is to provide a system which serves as a temporary attachment and which can be removed and stored or transferred to another vehicle for subsequent use.

Another object of the present invention is to provide a system that is simple to use, durable and which requires no special handling or storage.

Another object of the present invention is to provide a system which does not require any special, training or expertise to install or utilize.

Another object of the present invention is to provide a system that can be used by the operator of a vehicle without the aide of another individual.

There has thus been outlined, rather broadly, the more important features of the vehicle monitoring system in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

These together with other objects of the invention, along with the various features of novelty, which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a diagrammatic perspective view of the portable vehicle mounted monitoring system having a image receiving means attachable to the rear of a vehicle which relays real-time images to an image display means mountable inside the vehicle to assist an operator while traveling in the rearward direction.

FIG. 2 is a diagrammatic perspective view of the camera of the portable vehicle mounted monitoring system having a flexible sleeve for providing different viewing angles and mounting means for attachment to the rear of the vehicle.

FIG. 3 is a diagrammatic perspective view of the image display means of the portable vehicle mounted monitoring system attachable to the inside of the vehicle.

FIG. 4 is a side view of a vehicle onto which the image receiving means of the vehicle mounted monitoring system is attachable to the rear of the vehicle.

FIG. 5 is a diagrammatic perspective view of the preferred embodiment of the vehicle mounted monitoring system in use, wherein an attachment between the vehicle and a trailer is being made.

### DETAILED DESCRIPTION OF THE PREFERRED EMBODIMENTS

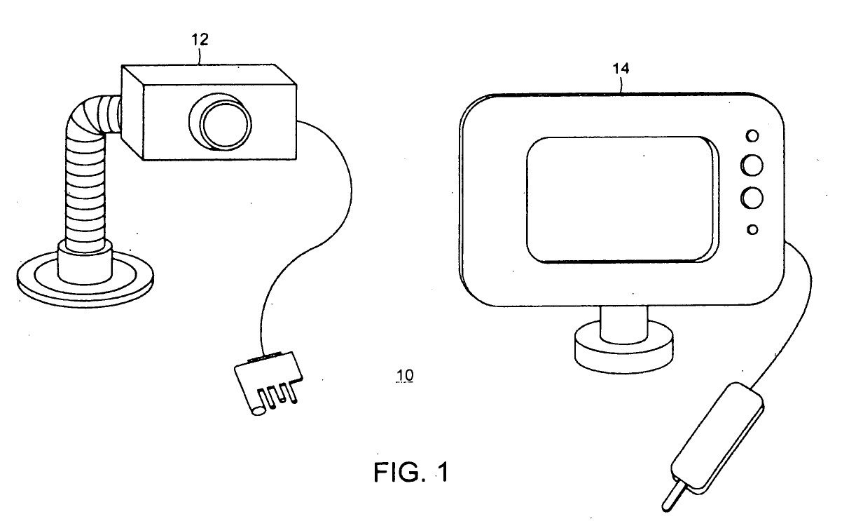

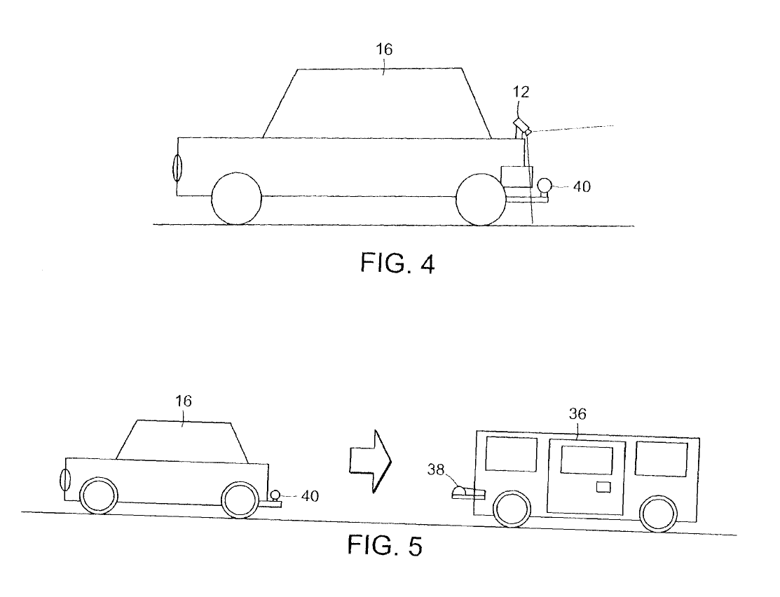

FIG. 1 illustrates a portable vehicle mounted monitoring system 10 having an image receiving means 12 and an image display means 14 for aiding an operator of a vehicle 16 (see FIG. 4A) traveling in a rearward direction. Preferably the image receiving means 12 is a camera and the image display means 14 is a monitor. The image receiving means 12 is attachable to the vehicle 16 (see FIG. 4) and relays real-time images via a wireless connection to the image display means 14 mounted inside the vehicle 16 as known in the art and readily apparent in many mechanisms of wireless signal art. Therefore, the system 10 allows an operator of vehicle 16 traveling in a rearward direction to view images directly behind his vehicle 16 that are undetectable given an operator's position in the vehicle 16. The system 10 allows an operator to view these images through the image display means 14 which is attachable on the inside of the vehicle 16, preferably on the dashboard, thus enabling an operator to travel in a rearward direction without a second individual providing direction and guidance for the vehicle 16.

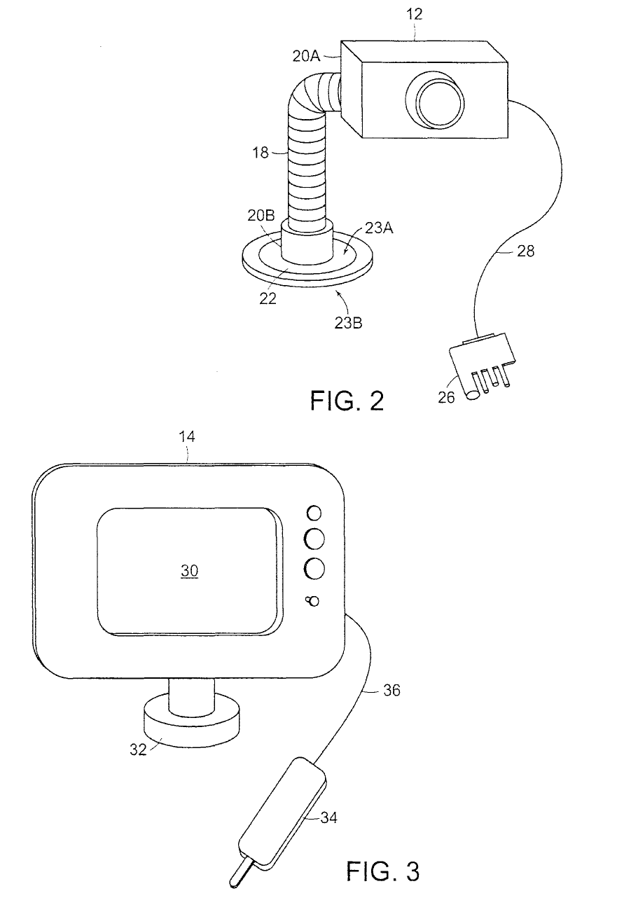

FIG. 2 illustrates the image receiving means 12 of the portable vehicle mounted monitoring system 10. The system 10 includes a flexible sleeve 18 having a first end 20A and second end 20B, wherein the first end 20A is connected to the image receiving means 12 allowing an operator to manipulate image receiving means for different viewing angles. A mounting apparatus 22, having a top 23A and a bottom 23B, wherein the second end 20B of the flexible sleeve 18 is connected to the top 23A of the mounting apparatus 22. The bottom 23B of the mounting apparatus 22 is attachable to the vehicle 16. Preferably the mounting apparatus 22 is a suction cup assembly 24 allowing for the system 10 to be attachable to the vehicle temporarily during use, allowing an operator to remove the image receiving means 12 upon completion of a specified task. Alternatively, the mounting apparatus 22 is a removeably attachable magnetic mechanism. Furthermore, a power supply connector 26 provides power to the image receiving means 12 via a wire 28 that connects the image receiving means 12 to the power supply connection 26. Preferably the power supply connection 26 is a four-wire flat trailer connector. Alternatively, the image receiving means 12 may receive power from a standard twelve volt battery, thereby eliminating the need for the image receiving means 12 to receive power from the vehicle 16.

FIG. 3 illustrates the image display means 14 of the portable vehicle mounted monitoring system 10. The image display means 14 preferably contains a liquid crystal display screen (“LCD) 30, allowing an operator to view real-time images from behind the vehicle 16 that are sent by the image receiving means 14 via a wireless connection. If an operator desires, the image display means 14 may be attachable to the inside of the vehicle by a mounting apparatus 32, allowing the operator to secure the image display means 14 preferably to the dashboard of the vehicle 16. Furthermore, a vehicle power supply connector 34 provides power to the image display means 16 via a wire 36 that connects the image display means 14 to the vehicle power supply connector 34. Preferably the vehicle power supply connector 34 is a cigarette lighter adapter allowing an operator to plug the vehicle power supply connector 34 into a standard cigarette lighter commonly available in many vehicles 16.

FIG. 4 illustrates the image receiving means 12 in use and equipped on the vehicle 16. Preferably the image receiving means 12 is attachable on the rear portion of the vehicle 16, such as a bumper. However, an operator possesses the option to place the image receiving means 12 anywhere on the rear portion of the vehicle 16, as the flexible sleeve 18 allows for the viewing angle of the image receiving means 12 to be manipulated.

FIG. 5 illustrates the preferred embodiment for the portable vehicle mounted monitoring system 10 in use, wherein a trailer 36 is in the working process of becoming attachable to the vehicle 16. In this embodiment, the trailer 36 contains a ball 38 that couples with a tow hitch 40 located on the vehicle 16. The system 10 aides an operator during this process by enabling an operator to guide the tow hitch 40 of the vehicle 16 without any assistance from another individual located outside the vehicle 16. The image display means 14 allows for an operator to view images directly behind the vehicle 16 while simultaneously observing the location of the ball 38 in relation to the tow hitch 40 without leaving the vehicle 16. Furthermore, the flexible sleeve 18 on the image receiving means 12 allows each operator to personally position and set the viewing angle of the image receiving means 12 in relation to the trailer 36 in the area each operator believes provides the greatest assistance in performing the above-referenced operation.

While several embodiments of the present invention have been illustrated by way of example, it is apparent that further embodiments could be developed within the spirit and scope of the present invention. However, it is to be expressly understood that such modifications and adaptations are within the spirit and scope of the present invention, as set forth in the following claims.

What is claimed is:

1. A portable vehicle mounted monitoring system comprising:
a) an image receiving means;
b) a flexible sleeve having a first end and a second end, said first end connectably disposed to said image receiving means;
c) a mounting apparatus having a top and a bottom, said top connectably disposed to said second end of said flexible sleeve, said bottom attachable to a vehicle;
d) a power supply connector comprising a wire connectably disposed between said image receiving means and said power supply connector for powering said image receiving means;
e) an image display means; and
f) a vehicle power supply connector comprising a wire connectably disposed between said image display means and said vehicle power supply connector.

2. The system of claim 1, further comprising a removeably attachable mounting apparatus connectably disposed to said image display means for attachment inside a vehicle.

3. The system of claim 2, wherein said removeably attachable mounting apparatus comprises a suction cup assembly disposed for attachment inside a vehicle.

4. The system of claim 3, wherein the power supply connector comprises a four-wire flat trailer connector.

5. The system of claim 4, wherein the image display means contains a liquid crystal display screen.

6. The system of claim 5, wherein the vehicle power supply connector is a cigarette lighter adapter.

7. The system of claim 6, wherein the mounting apparatus connectably disposed to the image receiving means comprises a suction cup assembly disposed for attachment outside the vehicle.

8. The system of claim 6, wherein the mounting apparatus connectably disposed to the image receiving means comprises a removeably attachable magnetic mechanism.

9. A portable vehicle mounted monitoring system for attaching a vehicle to a trailer, comprising:
a) an image receiving means;
b) a flexible sleeve having a first end and a second end, said first end connectably disposed to said image receiving means;
c) a mounting apparatus having a top and a bottom, said top connectably disposed to said second end of said flexible sleeve, said bottom attachable to a vehicle;
d) a power supply connector comprising a wire connectably disposed between said image receiving means and said power supply connector for powering said image receiving means;
e) an image display means; and
f) a vehicle power supply connector comprising a wire connectably disposed between said image display means and said vehicle power supply connector.

10. The system of claim 9, further comprising a removeably attachable mounting apparatus connectably disposed to said image display means for attachment inside a vehicle.

11. The system of claim 10, wherein said removeably attachable mounting apparatus comprises a suction cup assembly disposed for attachment inside a vehicle.

12. The system of claim 11, wherein the power supply connector comprises a four-wire flat trailer connector.

13. The system of claim 12, wherein the image display means contains a liquid crystal display screen.

14. The system of claim 13, wherein the vehicle power supply connector is a cigarette lighter adapter.

15. The system of claim 14, wherein the mounting apparatus connectably disposed to the image receiving means comprises a suction cup assembly disposed for attachment outside the vehicle.

16. The system of claim 14, wherein the mounting apparatus connectably disposed to the image receiving means comprises a removeably attachable magnetic mechanism.
